(19) United States
(12) Patent Application Publication
(10) Pub. No.: US 2002/0083545 A1
(43) Pub. Date: Jul. 4, 2002

(54) Pre-windshield wiper auxiliary device

(76) Inventor: Wen Hao Chen, Kaohsiung (TW)

Correspondence Address: BRUCE H. TROXELL, SUITE 1404, 5205 LEESBURG PIKE, FALLS CHURCH, VA, 22041, US

(21) Appl. No.: 10/028,490

(22) Filed: Dec. 28, 2001

(30) Foreign Application Priority Data
Jan. 2, 2001 (TW) 90200034

(51) Int. Cl. B60S 1/28; B60S 1/38

(52) U.S. Cl. 15/250.41; 15/250.4; 15/250.44

(57) ABSTRACT

Pre-windshield wiper auxiliary device which is detachably parallelly mounted on the arched arm of the windshield wiper. The auxiliary device includes an auxiliary unit and connecting members. The auxiliary unit includes a seat body provided with a wiping member and brush hairs. Each connecting member includes an upper bracket one end of which is resiliently connected with the seat body of the auxiliary unit. The wiping member of the seat body is section by section connected with several arched arms which are pivotally connected with the seat body, whereby the wiping member can more resiliently snugly attach to the arched surface of the windshield.

### BACKGROUND OF THE INVENTION

The present invention is related to pre-windshield wiper auxiliary device which is detachably mounted on the arched arm of the windshield wiper. The auxiliary device includes a wiping member which is section by section connected with several arched arms which are pivotally connected with the seat body, whereby the wiping member can more resiliently snugly attach to the arched surface of the windshield.

It is known that a windshield wiper serves to wiper off the oil, sand and other contaminants attaching to the surface of the windshield. A windshield wiper seat is generally simply equipped with a rubber wiping blade. In the case that dust particles or insect bodies or bird shit adheres to the windshield, the rubber wiping blade often fails to fully clean up the surface of the windshield or even makes the surface more dirty. Moreover, some dust particles have very high hardness so that when wiping the windshield, the dust particles are often entrained by the wiping blade to scrape the windshield and the wiping blade. An improved windshield wiper has been developed to solve this problem. A wiping blade is disposed on the windshield wiper seat. A longitudinal row of brush hairs are disposed on front or rear side of the wiping blade. When cleaning the windshield, the brush hairs serve to previously clear up the bird shit, insect bodies or dust and then wipe off other dirt. A wiping blade is integrally disposed on outermost side of the brush hairs. When the windshield wiper returns, the wiping blade helps in wiping off the rainwater. However, in such windshield wiper seat, the wiping blade is integrally formed with the brush hairs and lacks flexibility. When applied to arched surface of a windshield, such wiping blade can hardly achieve cleaning effect. In addition, the wiping blade is integrally formed with the brush hairs and cannot be detached therefrom. In case the windshield wiper is partially damaged, the entire wiper must be replaced. This leads to waste of resource.

### SUMMARY OF THE INVENTION

It is therefore a primary object of the present invention to provide a pre-windshield wiper auxiliary device which is detachably mounted on the windshield wiper seat. The auxiliary device includes an auxiliary unit and connecting members. The auxiliary unit includes a seat body provided with a wiping member and brush hairs. Each connecting member includes an upper bracket one end of which is resiliently connected with the seat body of the auxiliary unit. The wiping member of the seat body is section by section connected with several arched arms which are pivotally connected with the seat body, whereby the wiping member can more resiliently snugly attach to the arched surface of the windshield. The wiping member is an independent member and can be solely replaced. Therefore, waste is avoided.

The present invention can be best understood through the following description and accompanying drawings wherein:

### BRIEF DESCRIPTION OF THE DRAWINGS

FIG. 1 is a perspective exploded view of the pre-windshield wiper auxiliary device of the present invention;

FIG. 2 is a perspective assembled view of the pre-windshield wiper auxiliary device of the present invention; and

FIG. 3 is a sectional assembled view of the pre-windshield wiper auxiliary device of the present invention.

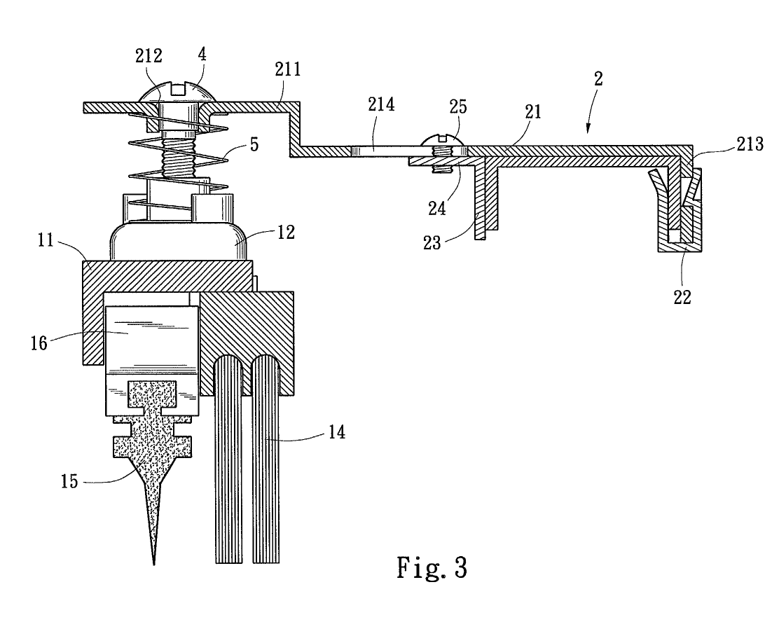

### DETAILED DESCRIPTION OF THE PREFERRED EMBODIMENTS

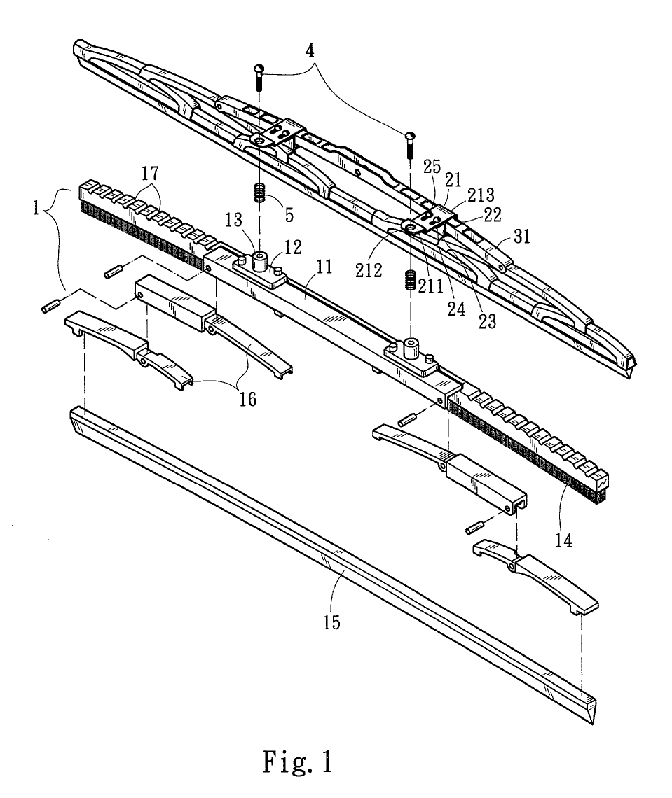

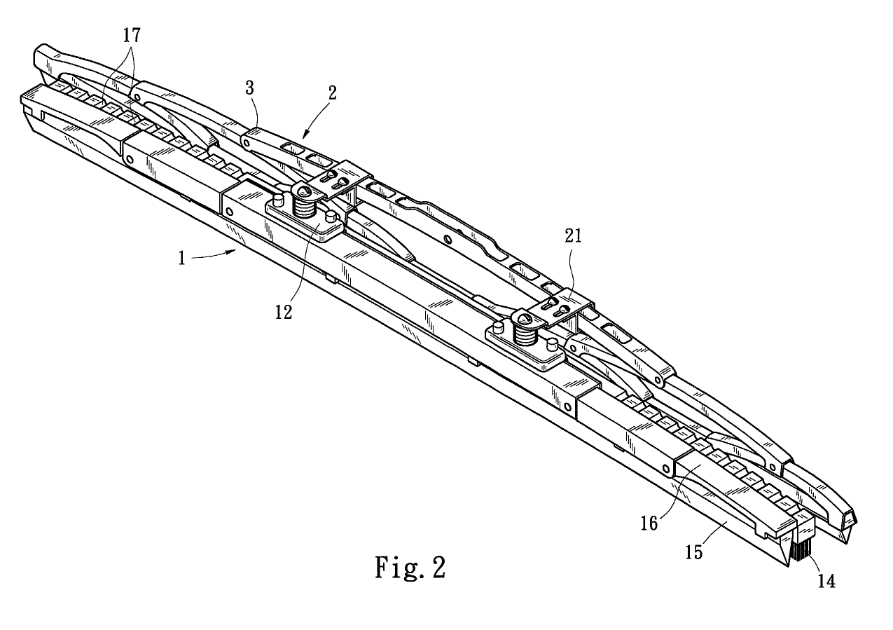

Please refer to FIGS. 1 and 2. The pre-windshield wiper auxiliary device of the present invention includes an auxiliary unit 1 and connecting members 2 extending from a lateral side of the auxiliary unit 1. The auxiliary unit 1 includes a seat body 11. Fixing blocks 12 are disposed on upper side of the seat body 11. Each fixing block 12 is formed with a thread hole 13. One end of an upper bracket 21 is formed with a fixing hole 212. A fixing member 4 is passed through the fixing hole 212 and screwed into the thread hole 13 to connect the upper bracket 21 on the seat body 11. A resilient member 5 is fitted around the fixing member 4 between the upper bracket 21 and the fixing block 12 to enhance the pressure strength of the auxiliary unit 1. The lower side of the seat body 11 is provided with multiple rows of longitudinally brush hairs 14 and a wiping member 15 on outermost side. The wiping member 15 is able to fully attach to the curved face of the windshield. Several sections of the wiping member 15 are respectively connected with several arched arms 16 which are pivotally connected with the seat body 11. The arched arms 16 are able to resiliently adapt the wiping member 15 to the surface of the windshield 6 section by section. Therefore, the wiping member 15 can more easily and naturally attach to the surface of the windshield 6 with varied curvature.

The connecting member 2 is composed of an upper bracket 21 with a certain width, an upper U-shaped fastening member 22 and a retaining member 23. One end of the upper bracket 21 is bent to form an upper bending section 211 formed with a fixing hole 212. The other end of the upper bracket 21 is bent to form a tail bending edge 213. The upper bracket 21 is formed with connecting hole 214. The fastening member 22 is used to clamp together the tail bending edge 231 of the upper bracket 21 and the combination of the bending edges of the arched arm 31 of the windshield wiper seat 3. The retaining member 23 has an extension plate 24. A fixing member 25 is used to lock the extension plate 24 at the connecting hole 214 of the upper bracket 21, whereby the retaining member 23 is leant against the front bending edge of the arched arm 31 of the windshield wiper seat. The wiping member 15 is an independent member and can be solely replaced. Therefore, waste is avoided.

The top face of the seat body 11 is formed with multiple recesses 17, whereby the seat body 11 can have better flexibility so that the brush hairs can more snugly attach to the surface of the windshield with varied curvatures.

The above embodiments are only used to illustrate the present invention, not intended to limit the scope thereof. Many modifications of the above embodiments can be made without departing from the spirit of the present invention.

What is claimed is:

1. Pre-windshield wiper auxiliary device comprising an auxiliary unit and connecting members extending from a lateral side of the auxiliary unit, the auxiliary unit including a seat body provided with a wiping member and brush hairs, each connecting member including an upper bracket, one end of the upper bracket being connected with the auxiliary unit, the other end of the upper bracket being formed with a tail bending edge for connecting the upper bracket with arched arm of the windshield wiper seat, said auxiliary device being characterized in that the wiping member is section by section connected with several arched arms which are pivotally connected with the seat body, whereby the wiping member can more resiliently snugly attach to the arched surface of the windshield.

2. Pre-windshield wiper auxiliary device as claimed in claim 1, wherein a tail end of the upper bracket is bent to form a tail bending edge for hooking and attaching to a rear bending edge of an arched arm of the windshield wiper seat, a fastening member being used to clamp the tail bending edge of the upper bracket and the rear bending edge of the arched arm together.

3. Pre-windshield wiper auxiliary device as claimed in claim 1, wherein fixing blocks are disposed on upper side of the seat body, each fixing block being formed with a thread hole, one end of the upper bracket being formed with a fixing hole, a fixing member being passed through the fixing hole and screwed into the thread hole to connect the upper bracket on the seat body, a resilient member being fitted around the fixing member between the upper bracket and the fixing block, whereby the fixing member can be tightened or loosened to adjust the height of the auxiliary device in accordance with the height of the windshield wiper seat.

4. Pre-windshield wiper auxiliary device as claimed in claim 2, wherein fixing blocks are disposed on upper side of the seat body, each fixing block being formed with a thread hole, one end of the upper bracket being formed with a fixing hole, a fixing member being passed through the fixing hole and screwed into the thread hole to connect the upper bracket on the seat body, a resilient member being fitted around the fixing member between the upper bracket and the fixing block, whereby the fixing member can be tightened or loosened to adjust the height of the auxiliary device in accordance with the height of the windshield wiper seat.

5. Pre-windshield wiper auxiliary device as claimed in claim 1, wherein the seat body is formed with multiple recesses, whereby the seat body has better flexibility and can more snugly attach to the surface of the windshield with varied curvatures.

6. Pre-windshield wiper auxiliary device as claimed in claim 2, wherein the seat body is formed with multiple recesses, whereby the seat body has better flexibility and can more snugly attach to the surface of the windshield with varied curvatures.
